(19) United States
(12) Patent Application Publication
(10) Pub. No.: US 2008/0024969 A1
(43) Pub. Date: Jan. 31, 2008

(54) COMPUTER CASE WITH STORAGE RECEPTACLE

(75) Inventors: KE SUN, Shenzhen (CN); XIAO-ZHU CHEN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/560,851

(22) Filed: Nov. 17, 2006

(30) Foreign Application Priority Data
Jul. 26, 2006 (CN) 200610061807.1

(51) Int. Cl. G06F 1/16

(52) U.S. Cl. 361/683; 361/679

(57) ABSTRACT

A computer case includes a front panel defining an access hole for an electric component passing through, and a storage receptacle mounted to the panel. The storage receptacle includes a blocking board mounted to the front panel to cover the access hole, and a cover board mounted to the blocking board. The cover board and the blocking board are configured for holding an object therebetween.

### BACKGROUND OF THE INVENTION

1. Field of the Invention

The invention relates to computer cases. In particular, the present invention relates to a computer case with a storage receptacle.

2. Description of related art

A conventional computer case usually has a plurality of access holes covered with blocking boards in a front panel. The blocking boards are removed when one of the access holes is used to receive a device such as a CD-ROM drive. Commonly, not all of the access holes are utilized and the blocking boards for those holes are left in place. This constitutes wasted space on the front panel.

What is needed is a computer case that allows the blocking boards left in place to serve a more useful purpose.

### SUMMARY OF THE INVENTION

An exemplary computer case includes a front panel defining an access hole for receiving an electronic component therein, and a storage receptacle mounted to the panel. The storage receptacle includes a blocking board mounted on the front panel to cover the access hole, and a cover board mounted to the blocking board. The cover board and the blocking board are configured for storing an object therebetween.

Other advantages and novel features will become more apparent from the following detailed description when taken in conjunction with the accompanying drawing, in which:

### BRIEF DESCRIPTION OF THE DRAWINGS

FIG. 1 is an exploded, isometric view of a computer case in accordance with a preferred embodiment of the present invention, the computer case has a storage receptacle;

FIG. 2 is an assembled view of FIG. 1;

FIG. 3 is an exploded, isometric view of the storage receptacle of FIG. 2;

FIG. 4 is a assembled view of FIG. 3, with the storage receptacle in an open position; and

FIG. 5 is similar to FIG. 4, but showing the storage receptacle in a closed position.

### DETAILED DESCRIPTION OF THE INVENTION

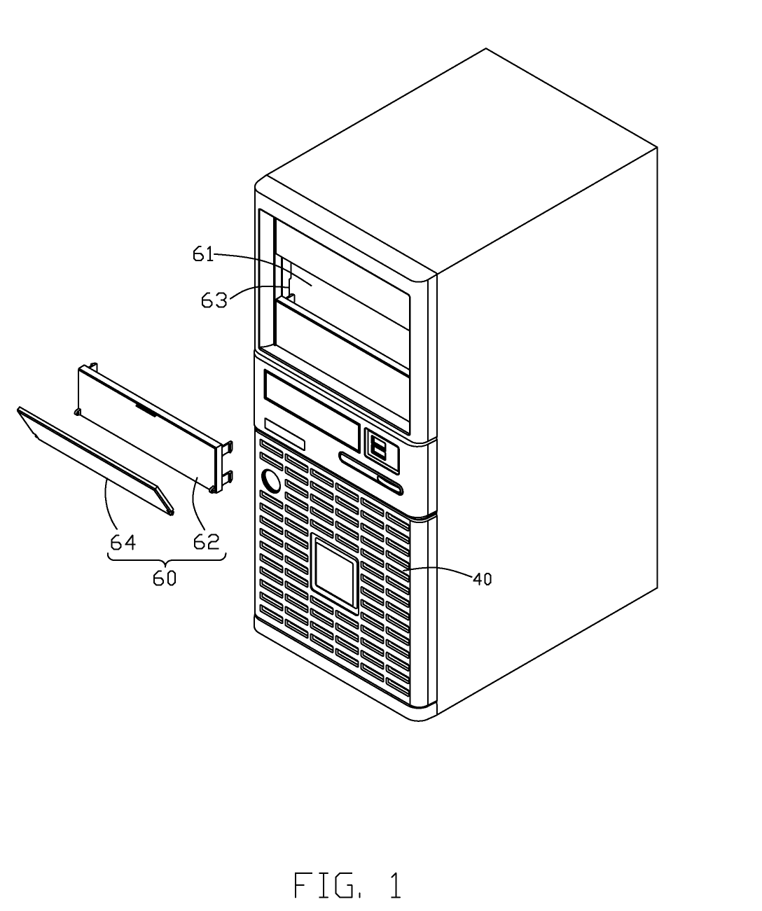

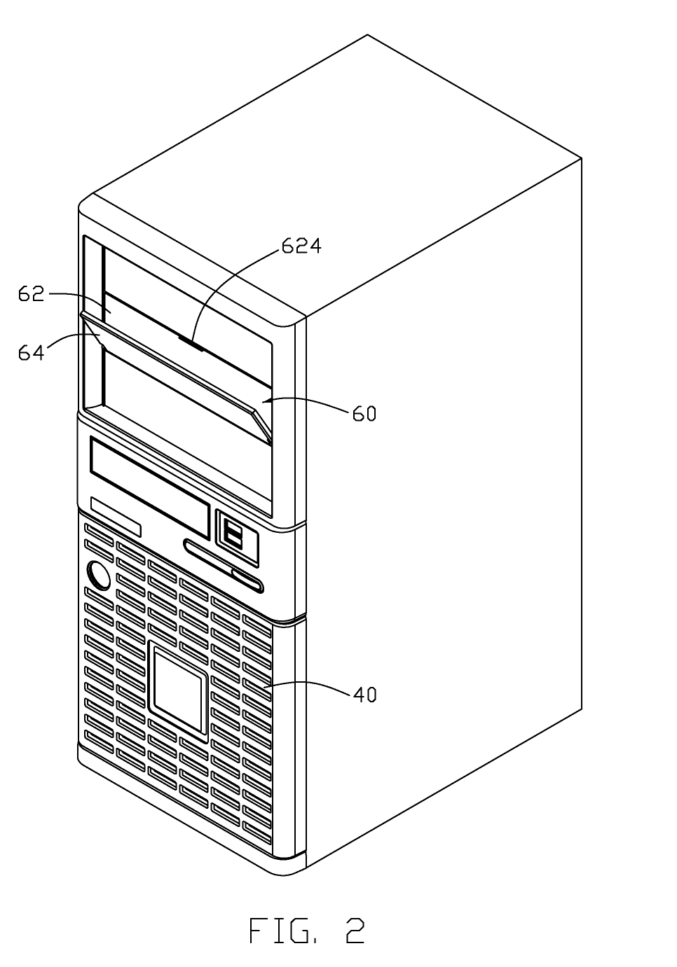

Referring to FIGS. 1 and 2, a computer case in accordance with a preferred embodiment of the present invention comprises a front panel 40, and a storage receptacle 60 mounted on an upper portion of the front panel 40.

The front panel 40 defines an access hole 61 for receiving an electric component such as a CD-ROM driver. The front panel 40 comprises two flanges 63 protruding in from opposite sides of the access hole 61.

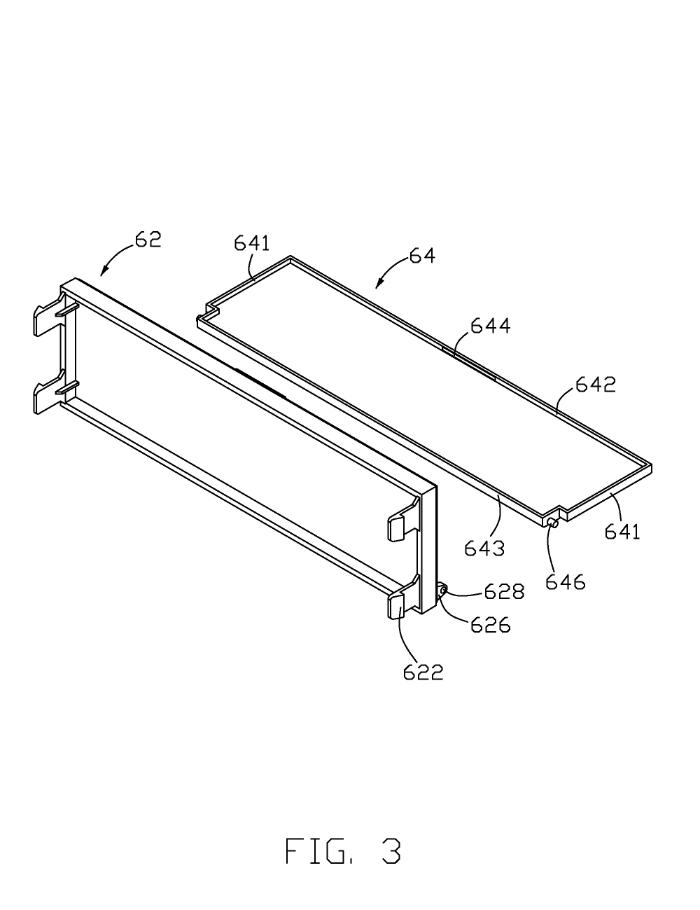

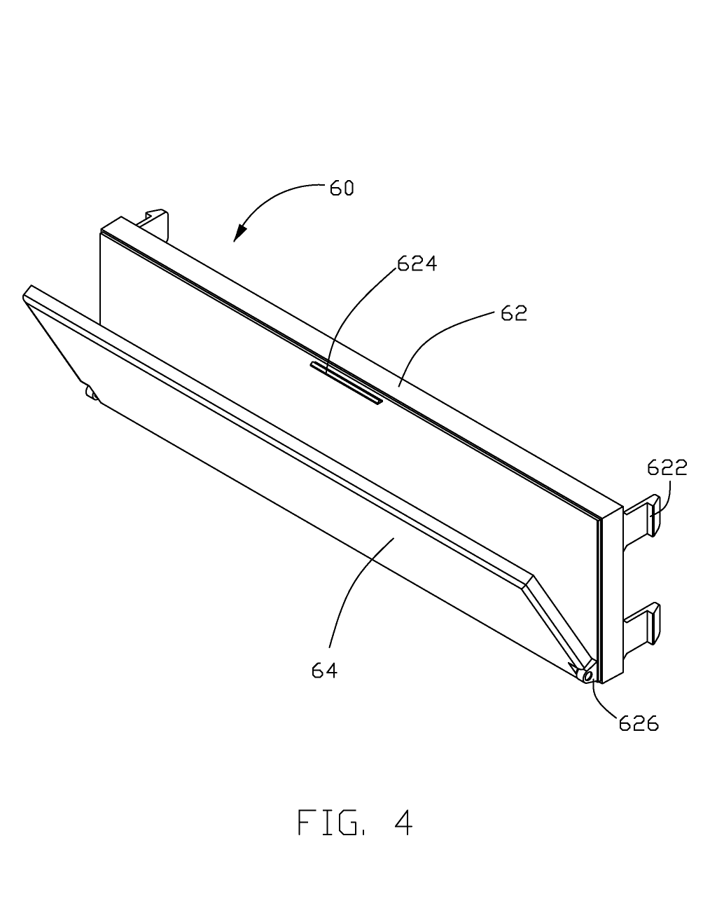

Referring also to FIGS. 3 and 4, the receptacle 60 comprises a blocking board 62, and a cover board 64 fastened to the blocking board 62.

The blocking board 62 having a rectangular shape comprises four hooks 622 perpendicularly extending in from opposite sides thereof, a protrusion 624 protruding out from an upper portion thereof used as a first joint portion, and two tabs 626 protruding out from opposite sides of a lower portion thereof opposite to the hooks 622. A pivot hole 628 is defined in each tab 626.

The cover board 64 comprises two side flanges 641, an upper flange 642, and a lower flange 643 perpendicularly extending in from four sides thereof. The two side flanges 641, the upper flange 642, and the lower flange 643 together define a receiving space. A slot 644 is defined in the upper flange 642 of the cover board 64 used as a second joint portion. A post 646 protrudes out from a lower portion of each side flange 641.

In assembly, the posts 646 of the cover board 64 are engaged in the corresponding pivot holes 628 of the tabs 626 of the blocking board 62. Thus, the cover board 64 is pivotably mounted to the blocking board 62. The four hooks 622 of the blocking board 62 are engaged with the corresponding flanges 63 of the front panel 40. Thus, the blocking board 62 is mounted to the front panel 40 to cover the access hole 61.

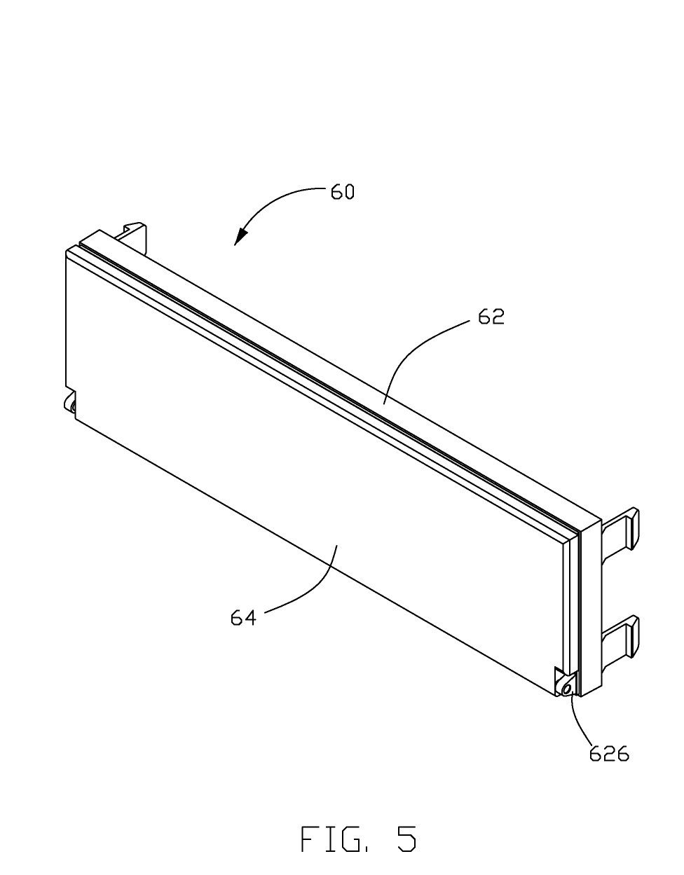

Referring also to FIG. 5, an object such as a subscriber identity module (SIM) card, a memory card, a picture, a notepad or other similar thin object (not shown) is placed in the receiving space of the cover board 64. The cover board 64 is pivoted toward the blocking board 62. The protrusion 624 (the first joint portion) of the blocking board 62 is engaged in the slot 644 (the second joint portion) of the cover board 64. Thus, the object is accommodated between the blocking board 62 and the cover board 64 for securing a more function to the computer case.

In other embodiments, positions of the first joint portion and the second joint portion may be interchanged and the first joint portion and the second joint portion may further comprise a plurality of slots and protrusions or other means to pivotably join the blocking board 62 and the cover board 64.

It is to be understood, however, that even though numerous characteristics and advantages of the preferred embodiments have been set forth in the foregoing description, together with details of the structures and functions of the embodiments, the disclosure is illustrative only, and changes may be made in detail, especially in matters of shape, size, equivalent material and arrangement of parts within the principles of the invention to the full extent indicated by the broad general meaning of the terms in which the appended claims are expressed.

What is claimed is:

1. A computer case, comprising:
a front panel defining an access hole for receiving an electric component; and
a storage receptacle comprising a blocking board mounted to the front panel to cover the access hole, and a cover board mounted to the blocking board, the cover board and the blocking board being configured for holding an object therebetween.

2. The computer case as claimed in claim 1, wherein the blocking board comprises four hooks perpendicularly extending in from opposite sides thereof, the front panel comprises two flanges protruding in from opposite sides of the access hole to engage with the hooks of the blocking board.

3. The computer case as claimed in claim 1, wherein the blocking board comprises two tabs protruding out from opposite sides of a lower portion thereof, a pivot hole is defined in each of the tabs, two post protrudes from the cover board to be pivotably engaged in the corresponding pivot holes of the blocking board.

4. The computer case as claimed in claim 3, wherein the blocking board comprises a first joint portion set on an upper portion thereof, the cover board comprises a second joint portion set on an upper portion thereof, the first joint portion and the second joint portion cooperate to fasten the blocking board to the cover board.

5. The computer case as claimed in claim 4, wherein the first joint portion of the blocking board comprises a protrusion protruding out from an upper portion of the blocking board, the cover board comprises an upper flange perpendicularly extending in from an upper side thereof, the second joint portion of the cover board comprises a slot defined in the upper flange corresponding to the protrusion of the blocking board.

6. The computer case as claimed in claim 5, wherein the cover board further comprises two side flanges perpendicularly extending in from opposite sides thereof, the posts of the cover board protrude out from the side flanges respectively.

7. The computer case as claimed in claim 6, wherein the cover board still further comprises a lower flange perpendicularly extending in from a lower side thereof.

8. The computer case as claimed in claim 7, wherein the two side flanges, the upper flange and the lower flange of the cover board together define a receiving space thereamong configured for accommodating the object.

9. A computer case, comprising:
a front panel defining an access hole for an electric component passing through;
a storage receptacle comprising a blocking board mounted to the front panel to cover the access hole, and a cover board pivotably mounted to the blocking board, the cover board and the blocking board being configured for holding an object therebetween.

10. The computer case as claimed in claim 9, wherein the blocking board comprises four hooks perpendicularly extending in from opposite sides thereof, the front panel comprises two flanges protruding in from opposite sides of the access hole to engage with the hooks of the blocking board.

11. The computer case as claimed in claim 9, wherein the blocking board comprises two tabs protruding out from opposite sides of a lower portion thereof, a pivot hole is defined in each of the tabs, two post protrudes from the cover board to be pivotably engaged in the corresponding pivot holes of the blocking board.

12. The computer case as claimed in claim 11, wherein the blocking board comprises a first joint portion set on an upper portion thereof, the cover board comprises a second joint portion set on an upper portion thereof, the first joint portion and the second joint portion are cooperated to fasten the blocking board to the cover board.

13. The computer case as claimed in claim 12, wherein the first joint portion of the blocking board comprises a protrusion protruding out from an upper portion of the blocking board, the cover board comprises an upper flange perpendicularly extending in from an upper side thereof, the second joint portion of the cover board comprises a slot defined in the upper flange corresponding to the protrusion of the blocking board.

14. The computer case as claimed in claim 13, wherein the cover board further comprises two side flanges perpendicularly extending in from opposite sides thereof, the posts of the cover board protrude out from the side flanges respectively.

15. The computer case as claimed in claim 14, wherein the cover board still further comprises a lower flange perpendicularly extending in from a lower side thereof, the two side flanges, the upper flange, and the lower flange of the cover board together define a receiving space configured for accommodating the object.

16. A computer case comprising:
a front panel defining an opening configured for providing an access for an electronic component to enter into the computer case;
a storage receptacle detachably mounted to the front panel and being removable from the front panel when the electronic component is needed to be installed into the computer case, the storage receptacle comprising a blocking board detachably mounted to the front panel to cover the opening before the electronic component is installed to the computer case, and a cover board mounted to the blocking board to define therebetween a receiving space;
a thin component received in the receiving space.

17. The computer case as claimed in claim 16, wherein the cover board is pivotably mounted to the blocking board via a pivot structure formed between the blocking board and the cover board.

18. The computer case as claimed in claim 16, wherein a locking structure is formed between the blocking board and the cover board for detachably locking the cover board with the blocking board.

19. The computer case as claimed in claim 16, wherein one of the cover board and the blocking board comprises a plurality of flanges integrally extending therefrom toward the other one of the cover board and the blocking board, the flanges enclosing the receiving space.

20. The computer case as claimed in claim 16, wherein the thin component is one of SIM card, memory card, picture and notepad.
